(19) United States
(12) Patent Application Publication
(10) Pub. No.: US 2012/0154906 A1
(43) Pub. Date: Jun. 21, 2012

(54) Glaraser

(76) Inventor: Pallavi Tatapudy, Suffern, NY (US)

(21) Appl. No.: 12/972,338

(22) Filed: Dec. 17, 2010

(51) Int. Cl. G02B 5/23; G02B 1/10; B32B 17/10; B32B 5/00; B32B 37/02; B05D 5/06

(52) U.S. Cl. 359/359; 156/60; 427/163.1; 428/426; 428/220; 359/614

(57) ABSTRACT

The current invention is a new glass windshield with a transition-lens type composition layer between the glass substrates for use in vehicles (airplanes, ships, boats, sailboats, steamers, yachts, jets, and cars) or residential and commercial buildings to protect against sun glare and provide an overall cooling effect on the passengers or inhabitants. Rather than permanently tinting the glass of windshields and windows, the current invention works only when needed. It activates in the presence of sunlight. By not darkening unnecessarily, it avoids the consistent darkening of the interior of a vehicle (airplanes, ships, boats, sailboats, steamers, yachts, jets, and cars), viewing panel of an accessory such as a motorcycle or skydiving helmet, or residential and commercial buildings, as is the problem with tinted glass. The new glass windshield can be used as is or as a detachable or attachable unit.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE OR A COMPUTER PROGRAM LISTING COMPACT DISC APPENDIX

Not applicable

### BACKGROUND OF THE INVENTION

Conventional windshields are designed to keep the driver protected in case of an accident. They are made up of a tear-resistant plastic inner layer surrounded by one sheet of shatter glass on either side to form a laminate. Upon impact in an accident, the plastic layer remains intact and the shattered glass is embedded in the plastic, thus protecting the driver from injury from sharp glass pieces. Although traditional windshields block and filter ultraviolet radiation, it is only to a limited extent and they do not protect against the sun's glare. The glare of the sun results in hazardous driving conditions by distracting the driver and passengers. This is why a new glass windshield with a photochromic transition-lens type composition layer between the glass substrates is necessary.

Conventional removable sun glare protectors exist but are not made of photochromic transition-lens type material, lack complete protection from sun glare and block the viewer's vision. A means of completely blocking sun glare without loss of clear vision has not yet been invented. This confirms the non-obvious and unique nature of the current invention.

### BRIEF SUMMARY OF THE INVENTION

In the history of U.S. car manufacturing within the past 200 plus years, a new glass windshield or a removable photochromic transition-lens type unit has not been invented. As of today, it does not exist, which confirms the non-obvious and unique nature of the current invention. A new glass windshield with a transition-lens type composition layer between the glass substrates for use in vehicles (airplanes, ships, boats, sailboats, steamers, yachts, jets, and cars), accessories such as motorcycle and skydiving helmets, or residential and commercial buildings is being proposed. It will provide protection against the sun's glare and provide an overall cooling effect on the passengers or inhabitants. Rather than permanently tinting the glass of windshields and windows, the current invention will work only when needed. The current invention will be activated when in the presence of sunlight and will not darken unnecessarily. It will have a similar function to transition eyeglass lenses. It will avoid the consistent darkening of the interior of a vehicle (airplanes, ships, boats, sailboats, steamers, yachts, jets, and cars), an accessory such as a motorcycle or skydiving helmet, or residential and commercial buildings, as is the problem with tinted glass.

Another aspect of this invention involves a removable photochromic transition-lens type unit. In the history of U.S. car manufacturing within the past 200 plus years, a removable photochromic transition-lens type unit to protect against sun glare with clear visibility has not been invented. As of today, it does not exist, which confirms the non-obvious and unique nature of the current invention.

This is why a new glass windshield or a removable photochromic transition-lens type unit is necessary.

### BRIEF DESCRIPTION OF THE SEVERAL VIEWS OF THE DRAWING

Not Applicable

### DETAILED DESCRIPTION OF THE INVENTION

Windshield glass is composed of numerous oxides that fuse and react together upon heating to form a glass. These include silica (SiO₂ derived from sand), sodium oxide (Na₂O derived from soda ash or Na₂CO₃), calcium oxide (CaO derived from limestone or CaCO₃), potassium oxide (K₂O derived from potash), magnesium oxide (MgO), and aluminum oxide (Al₂O₃ derived from feldspar). The raw materials listed above are carefully weighed in the appropriate amounts and mixed together with a small amount of water to prevent segregation of the ingredients. Cullet (broken waste glass) is also used as a raw material. Once the batch is made, it is fed to a large tank for melting using the float.

The glass for windshields is made using the float glass process. In this method, the raw material is heated to a molten state and fed onto a bath of molten tin. In the float chamber, the glass doesn't submerge into the tin but floats on top of it, moving through the tank as though on a conveyor belt. The perfectly flat surface of the tin causes the molten glass also to become flat, while the high temperatures clean the glass of impurities. The decreased temperature at the exit of the chamber allows the glass to harden enough to move into the next chamber, a furnace. After exiting the lehr and cooling to room temperature, the glass is cut to the proper shape and tempered. The float chamber is very large—from about 13 feet to 26.25 feet (4 to 8 meters wide and up to almost 197 feet (60 meters) long; at its entrance, the temperature of the tin is about 1,835 degrees Fahrenheit (1,000 degrees Celsius), while at the exit the tin's temperature is slightly cooler—1,115 degrees Fahrenheit (600 degrees Celsius).

Cutting and tempering: The glass is cut into the desired dimensions using a diamond scribe—a tool with sharp metal points containing diamond dust. Diamond is used because it is harder than glass. The scribe marks a cut line into the glass, which is then broken or snapped at this line. This step is usually automated and is monitored by cameras and optoelectronic measuring systems. Next, the cut piece must be bent into shape. The sheet of glass is placed into a form or mold of metal or refractory material. The glass-filled mold is then heated in a furnace to the point where the glass sags to the shape of the mold. After this shaping step, the glass must be hardened in a heating step called tempering. First, the glass is quickly heated to about 1,565 degrees Fahrenheit (850 degrees Celsius), and then it is blasted with jets of cold air. Called quenching, this process toughens the glass by putting the outer surface into compression and the inside into tension. This allows the windshield, when damaged, to break into many small pieces of glass without sharp edges. The size of the pieces can also be changed by modifying the tempering procedure so that the windshield breaks into larger pieces, allowing good vision until the wind-shield can be replaced.

Laminating: After the glass is tempered and cleaned, it goes through a laminating process. In this process, two sheets of glass are bonded together with a layer of plastic (the plastic layer goes inside the two glass sheets). The lamination takes place in an autoclave, a special oven that uses both heat and pressure to form a single, strong unit that is resistant to tearing. The plastic interlayer is coated with organic photochromic molecules such as oxazines and naphthopyrans, to achieve an ultraviolet radiation and sun glare resistant windshield material with new photochromic characteristics. It acts as an ultraviolet filter that becomes tinted when exposed to sun glare, but returns back to its clear state in the absence of sun glare. A typical laminated windshield is very thin: each glass layer is approximately 0.03 inch (0.76 millimeter) thick, while the plastic interlayer is approximately 0.098 inch (2.5 millimeters) thick.

Finished Windshield: A finished windshield consists of two glass layers sandwiched around a plastic interlayer. Although very thin—about 0.25 inch thick—such laminated glass is very strong and is less likely to shatter than normal safety glass. In the United States, windshields are required by law to be made of laminated glass.

Assembly: After laminating, the windshield is ready to be assembled with plastic moldings so it can be installed in a vehicle. Known as glass encapsulation, this assembly process is usually done at the glass manufacturer. First, the peripheral section of the windshield is set in a predetermined position in a mold cavity. Next, molten plastic is injected into the mold; when it cools, it forms a plastic frame around the glass. The installation is done by direct glazing, a process that uses a polyurethane adhesive to bond the windshield and vehicle body.

1. A new composition for a windshield material consisting of a new tear-resistant plastic inner layer (as per claim 2) with 1 glass substrate (as per claim 3) on either side, prepared according to the procedure described in the invention, in the section titled, “Detailed Description of Invention.”

2. A method of preparing the new tear-resistant plastic inner layer, listed in claim 1, by directly coating the current standard tear-resistant plastic inner layer of a windshield before lamination, with organic photochromic molecules such as oxazines and naphthopyrans, to achieve an ultraviolet radiation and sun glare resistant windshield material with new photochromic characteristics, as described in the invention, in the section titled, “Detailed Description of Invention.”

3. The composition of the glass substrates listed in claim 1 will contain silica (SiO₂ derived from sand), sodium oxide (Na₂O derived from soda ash or Na₂CO₃), calcium oxide (CaO derived from limestone or CaCO₃), potassium oxide (K₂O derived from potash), magnesium oxide (MgO), and aluminum oxide (Al₂O₃ derived from feldspar) and will be prepared as per the procedure described in the invention, in the section titled, “Detailed Description of Invention.”

4. Another method of preparing a new windshield material by modifying the glass substrates mentioned in claim 3, by embedding microcrystalline silver halides (usually silver chloride) directly onto glass substrates to achieve an ultraviolet radiation and sun glare resistant glass photochromic windshield.

5. The new glass windshield prepared as per claim 1 or 4, with the new tear-resistant plastic inner layer as per claim 1, will act similar to transition eyeglass lenses in their function of protecting those wearing accessories like motorcycle helmets and skydiving helmets, those living in residential or commercial facilities with large glass windows, and those driving vehicles like airplanes, ships, boats, sailboats, steamers, yachts, jets, and cars, from harmful and distracting ultraviolet radiation and sun glare.

6. A method of resisting glare from the sun and avoiding the build-up of excessive heat in a residential or commercial facility or vehicle, due to the temporary tinting feature of the new glass windshield prepared as per claim 1 or 4, in the presence of sunlight.

7. A method of resisting glare from the sun and avoiding the build-up of excessive heat in a car with front and rear windshields, and side glass windows, due to the temporary tinting feature of the new glass windshield prepared as per claim 1 or 4, in the presence of sunlight.

8. A method of resisting glare from the sun and avoiding the build-up of excessive heat in an airplane and jet with a front windshield and multiple side glass windows, due to the temporary tinting feature of the new glass windshield prepared as per claim 1 or 4, in the presence of sunlight.

9. A method of resisting glare from the sun and avoiding the build-up of excessive heat in a ship, boat, sailboat, steamer, and yacht with front and rear windshields, and side glass windows, due to the temporary tinting feature of the new glass windshield prepared as per claim 1 or 4, in the presence of sunlight.

10. A method of resisting glare from the sun and avoiding the build-up of excessive heat in a motorcycle helmet and skydiver helmet, due to the temporary tinting feature of the new glass windshield prepared as per claim 1 or 4, in the presence of sunlight.

11. A method of reducing the risk of skin cancer and sun poisoning by minimizing exposure to ultraviolet radiation through the use of the new glass windshield material prepared as per claim 1 or 4 for windows of residential or commercial facilities, windshields of vehicles (airplanes, ships, boats, sailboats, steamers, yachts, jets, and cars) and viewing panels of motorcycle and sky diving helmets.

12. A removable or detachable overhanging unit as per the dimensions listed in claim 13, in front of the driver and/or front passenger of any vehicle (airplanes, ships, boats, sailboats, steamers, yachts, jets, and cars) separate from the windshield, (replacing the current opaque, non-glass detachable unit) made from the new glass windshield prepared as per claim 1 or 4.

13. The dimensions of all modified versions of the new glass windshield can vary and be customized for vehicles (airplanes, ships, boats, sailboats, steamers, yachts, jets, and cars) to cover a portion or the entire windshield, with the whole windshield having an area of approximately 2160 square inches (approximately 60 inches by 36 inches), the removable unit having an area of approximately 152 square inches (approximately 19 inches by 8 inches) and the attachable unit having an area of approximately 621 square inches (approximately 27 inches by 23 inches).

14. An attachable unit of dimensions listed in claim 13, made from the new glass windshield prepared as per claim 1 or 4, that can be attached on the inside of a section or entire area of the front windshield of any vehicle (airplanes, ships, boats, sailboats, steamers, yachts, jets, and cars), on the inside or outside of windows of residential or commercial facilities, and on the outside of viewing panels of motorcycle and sky diving helmets, to protect against ultraviolet radiation and sun glare.

15. A method of installing the new glass windshield prepared as per claim 1 or 4 that does not require replacing the whole front current-standard windshield with the new glass material, but modifying only a portion of the current-standard windshield as per the dimensions listed in claim 13 by incorporating the new (ultraviolet radiation and sun glare-resistant) tear-resistant plastic inner layer resin into the current-standard windshield.

16. A new (ultraviolet radiation and sun glare resistant) tear-resistant plastic inner layer resin prepared as per claim 2, as a resin mix in a container that can be added in between the glass layers of the current standard windshield, as per the dimensions listed in claim 13, to modify the current standard windshield.

17. The invention will generically be called Glaraser. Each vehicle and accessory will have different names, such as Carglaraser for cars, Planeglaraser for airplanes, Shipglaraser for ships, Boatglaraser for boats, Sailglaraser for sailboats, Steamboatglaraser for steamboats, Yachtglaraser for yachts, Jetglaraser for jets, Motorglaraser for motor cycle helmets, and Skyglaraser for sky diving helmet
